(19) United States
(12) Patent Application Publication
(10) Pub. No.: US 2013/0079964 A1
(43) Pub. Date: Mar. 28, 2013

(54) VEHICLE COMMUNICATION, ANALYSIS AND OPERATION SYSTEM

(71) Applicants: Anwar Mohamad Farid Sukkarié, Vancouver (CA); Clive Richard Wright, Vancouver (CA); Bruce William Adams, West Vancouver (CA)

(72) Inventors: Anwar Mohamad Farid Sukkarié, Vancouver (CA); Clive Richard Wright, Vancouver (CA); Bruce William Adams, West Vancouver (CA)

(73) Assignee: SATURNA GREEN SYSTEMS INC., Vancouver (CA)

(21) Appl. No.: 13/616,132

(22) Filed: Sep. 14, 2012

Related U.S. Application Data
(60) Provisional application No. 61/539,659, filed on Sep. 27, 2011.

(51) Int. Cl. G06F 17/00

(52) U.S. Cl. 701/22; 701/1

(57) ABSTRACT

The present invention provides a communication and analysis system that can manage data operations with a vehicle centric system with a planned route path. A vehicle that is in a communications link with a network can also manage its activities based on real time, historical and predictive knowledge, without having this all knowledge processing on board. Such data processing would include a cluster analysis of geo-spatial, internal functions and operator specific requirements. The rule based system would also incorporate the use patterns of a specific vehicle, or a specific user. A vehicle operator or vehicle multiple operators could share or upload information that would assist with efficient data processing and display, including fuel conservation and time management. Cluster weighting patterns can be assigned based on activities as efficient operation, safe travel and navigation.

### CROSS-REFERENCE TO RELATED APPLICATION

This patent application is based on and claims the benefit of priority from U.S. Provisional Patent Application Ser. No. 61/539,659, filed on Sep. 27, 2011, the contents of which are incorporated by reference in its entirety and assigned to the assignee of the present invention.

### NOTICE REGARDING COPYRIGHTED MATERIAL

A portion of the disclosure of this patent document contains material which is subject to copyright protection. The copyright owner has no objection to the facsimile reproduction of the patent document or the patent disclosure as it appears in the Patent and Trademark Office file or records, but otherwise reserves all copyright rights whatsoever.

### FIELD OF THE INVENTION

The present invention pertains to the field of vehicle operations and in particular to control and decision management.

### BACKGROUND

The operating mode of an electric vehicle is often characterized by its time until recharge and the options surrounding this. Existing methods of power management to optimize the electric-drive mode include rule based control algorithms, based on static variables, pattern recognition can include current driving patterns such as acceleration, regenerative-braking energy and stop time.

Dynamic programming algorithms have been used, based on the knowledge of real-time data to model a trip. Simulations have included intelligent traffic systems and global positioning systems technologies in analytical models. Real time traffic data can be analyzed to optimized operations and have been used in geographic scaling to localize the inputs to attempt to reduce computational requirements. Vehicle power management systems can include real-time traffic data such as traffic flow, traffic light stop time, traffic congestion and so on in a predictive energy management system.

Efforts to improve performance have included the use of traffic data including traffic flow, intersection light status to determine if alternative routes should be considered. Operation modes including vehicle speed, transmission gear and state of charge. Trip modeling has included road conditions such as slope and distance, incorporating global positioning systems and re-routing following the processing of traffic data.

However, electric vehicle systems are multi variable dynamic systems and as noted there are high computational loads to integrate real-time traffic data. Electric vehicles also need to boost performance requirements in order to become more accepted in comparison to internal combustion engines.

There is an increasing demand for these types of applications as operators become more continuously connected with their network needs. As the cost of providing networked services is reduced and the need increases so will the operator expectations for mobile vehicle systems.

One shortcoming of present art systems is that they are limited complex processing of vehicle centric real time information in combination with relative geospatial information. This cannot presently be efficiently managed, and this limits the ability of systems to provide useful real time predictive analytics. This is further restricted by the ability to manage vast numbers of distributed inputs on an ongoing basis.

Therefore there is a need to provide improved mobile telematics and navigation and improved means for managing this information.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a vehicle communication, analysis and operation system including hardware, firmware and software for managing vehicles by onboard analysis centered around a reference algorithm that uses the minimum amount of data in order to provide the vehicle operator with relevant data, employing inputs from data clusters including vehicle and correlation with analysis techniques in real time, or with historical and predictive knowledge and that further enables a multitude of applications, range optimization and electric vehicle charging infrastructure and that further enables range optimization algorithms performed on board

Another object of the present invention is to provide system where a vehicle is equipped with multiple accelerometers can derive the variations in conditions such as vehicle vibrations or acceleration in multiple axes and in combination with other data form a data cluster that can transit through a geometric model.

Another object of the present invention a vehicle communication, analysis and operation system. The present invention provides a system, including hardware, firmware and software for managing vehicles by employing continuous inputs from a vehicle and correlation with analysis techniques. A rule based system can manage the data operations of a vehicle. A vehicle that is in a communications link with a network can also manage its activities based on real time, historical and predictive knowledge, without having all this knowledge processing on board. Such data processing would include the geo-spatial, internal functions and operator specific requirements. The rule based or analysis system would also incorporate the use patterns of a specific vehicle, or a specific user. A use pattern could be transferred from one operator to another or be shared to assist with navigation and operations. A vehicle operator or vehicle multiple operators or a vehicle network component or a vehicle in communication with another, could share or upload information that would assist with efficient operations, including fuel conservation and time management. Use patterns can be assigned to geospatial regions and be used for comparative analysis for such activities as efficient operation, safe travel, social media applications and navigation.

A further object of the present invention is to provide a system where driver or vehicle preferences act as inputs to a rule based system allowing optimization of real time processing and where predictive aspects of what is happening on a driver dashboard can be displayed or shared on a network.

A further object of the present invention is to provide a method of analysis that minimizes the computational load on a network, and on board a vehicle by providing multiple algorithms to provide both an limited geometrical analysis and a server side analysis.

### BRIEF DESCRIPTION OF THE DRAWINGS

FIG. 1. Shows the data processing modules

FIG. 2. Shows the user configured settings and preferences.

FIG. 3. Shows the network components and communications modules

FIG. 4. Shows the iterative cycle

FIG. 5. Shows and example of a use case architecture

FIG. 6A. Shows the spatial geometry of a limited geometrical model wherein a vehicle traveling from A to B is deemed to pass through C

FIG. 6B. Shows the spatial geometry of a limited geometrical model wherein a vehicle traveling from A to B is deemed to pass through C where C represents a city block

FIG. 7. Shows how the model has a maximum limited deviation

FIG. 8A. Shows a simple display of fuel data using graphics that show fuel available (top) and fuel needed (bottom).

FIG. 8B. Shows a simple display of fuel data using graphics that show fuel available (top); with fuel needed and a confidence measure (bottom).

FIG. 9A. Shows the cluster geometry and the transit of a vehicle fd through a cluster or group of clusters.

FIG. 9B. Shows the cluster impacts and the transit of a vehicle fd through a cluster or group of clusters.

FIG. 10. Shows where fd is a simplification of complex analysis for a transit path

FIG. 11. Shows the influences of messaging between clusters will depend on the weighted value of a cluster as a vehicle transits a cluster field.

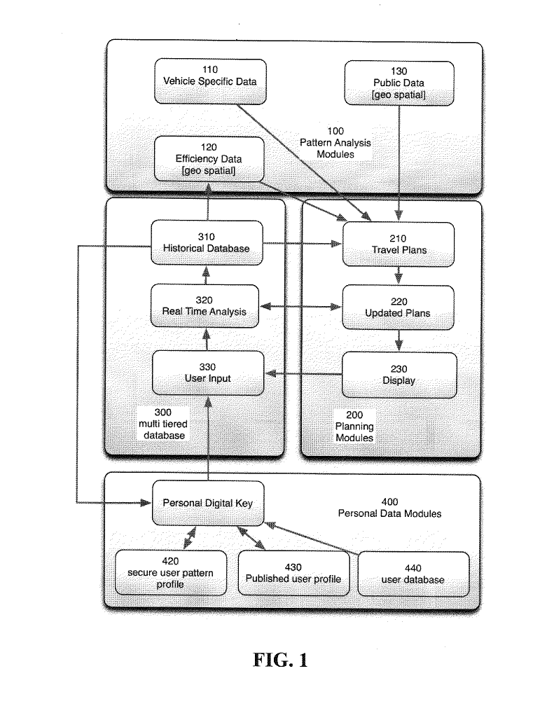

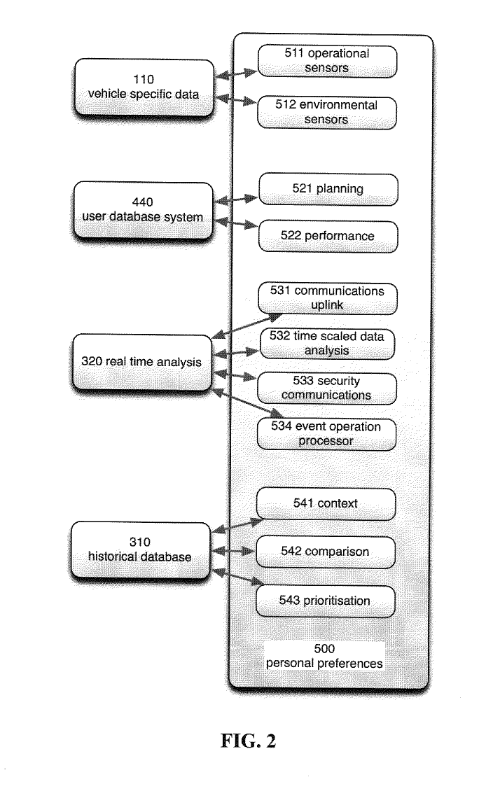

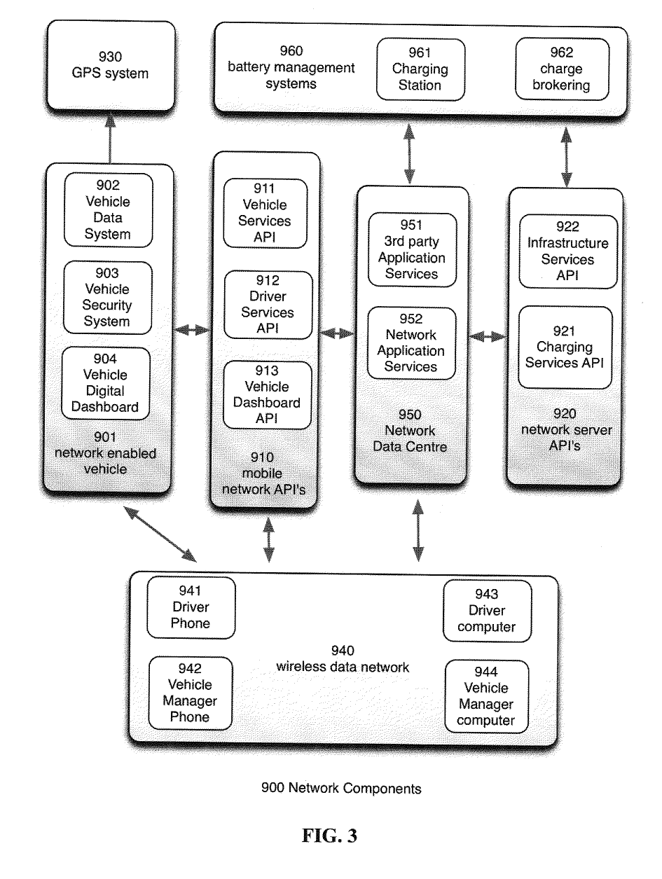

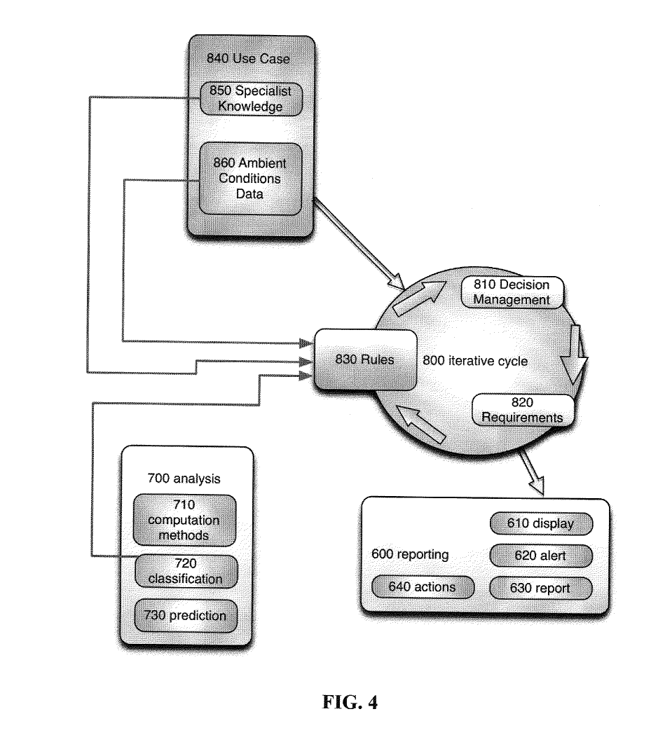

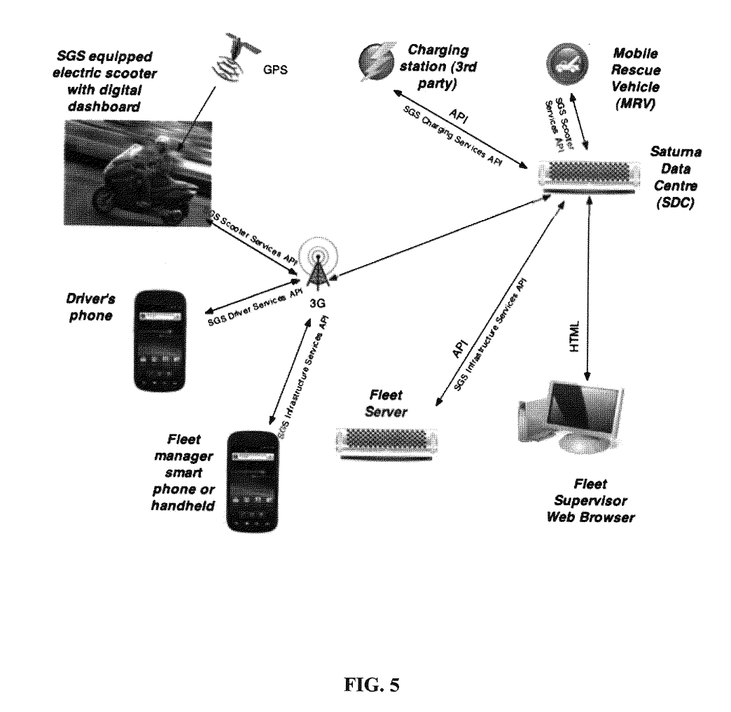

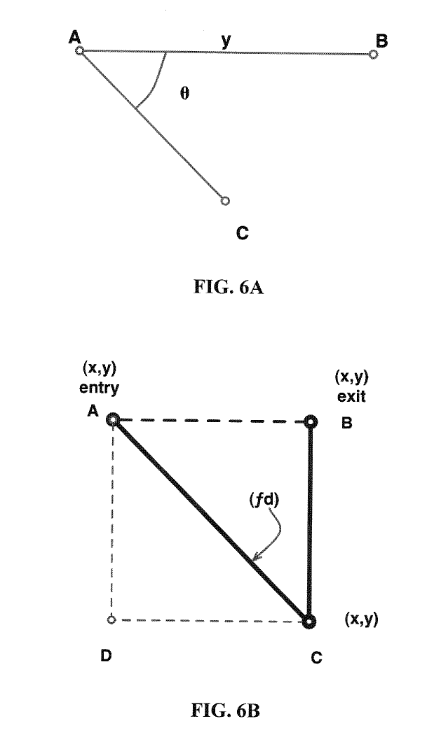

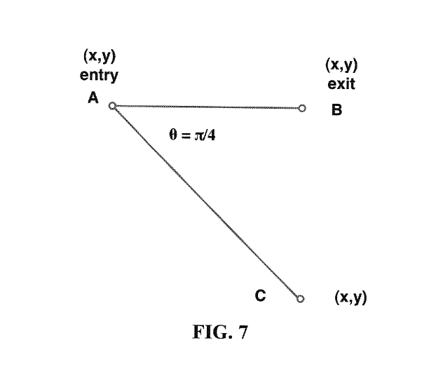

### DETAILED DESCRIPTION OF THE INVENTION

### Definitions

The term “alerts,” “commands” and “actions” may be referred to as “rules” herein for simplicity.

The term “preferences” refers to the user defined aspects of the invention including settings that are adjustable by drivers, systems operators, or automatically by analysis systems or network control operations, and can include adjustments made on a real time basis or based on historical use.

The terms “network” and “mobile data network” can be used interchangeably with mobile network, data network or network without limiting their meaning, and includes the use of 2G, 3G, 4G, WiFi, WiMAX, Wireless USB, Zigbee, Bluetooth and satellite, and for convenience could also include hard wired connections such as internet, ADSL, DSL, cable modem, T1, T3, fibre, dial-up modem or the use of flash memory data cards, USB memory sticks where appropriate.

The term “vehicle operation system” can refer to any component in this invention and its network and any or all the features of the invention without limitation.

The terms “operator,” “driver,” and “owner,” are used in context to describe the association of a person with a vehicle and the network and may in some cases be the same person.

The term “vehicle centric” means a focus on virtual data or remote services that support the use cases of rules and applications on a vehicle operating system, in a process designed to reduce the processing burden on the vehicle operating system, while still providing rich data for the operators and drivers.

The term “fuel” means available energy such as but not limited to the electrical potential stored in a battery or the potential energy that could be created in a fuel cell, or the amount of physical fuel in a tank.

The term “limited geometric model” means an algorithm designed to run onboard a vehicle that provides a minimum amount of processing as might be required in a model that does not compensate for all variables, but looks at the most common factors that might influence a vehicles' efficiency and then subsequently assigns a weighted value that has a maximum influence.

The term “cluster” means a region, area, or the variables within an area or onboard a vehicle, whether local or distributed that can be assigned to properties of the combination factors that have relationships in a computational analysis and where there is a need to simplify the reporting of these factors by weighting their influence in a computation, and in some cases predetermining if to include certain cluster values in an analysis.

The term “server side analysis” means centralized data from a multi dimensional acquisition methodology including cluster analysis, event correlations and root cause analysis to create vehicle operations range and route analysis, including probabilistic and predictive analyses.

The term “on board analysis” means a vehicle centric data acquisition and processing including an limited geometric model, and cluster analysis with connection to the server side analysis.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

An object of the present invention is to provide a vehicle communication, analysis and operation system including hardware, firmware and software for managing vehicles by onboard analysis centered around a reference algorithm that uses the minimum amount of data in order to provide the vehicle operator with relevant data, employing inputs from data clusters including vehicle and correlation with analysis techniques in real time, or with historical and predictive knowledge and that further enables a multitude of applications, range optimization and electric vehicle charging infrastructure and that further enables range optimization algorithms performed on board

Another object of the present invention is to provide system where a vehicle is equipped with multiple accelerometers can derive the variations in conditions such as vehicle vibrations or acceleration in multiple axes and in combination with other data form a data cluster that can transit through a geometric model.

Another object of the present invention a vehicle communication, analysis and operation system. The present invention provides a system, including hardware, firmware and software for managing vehicles by employing continuous inputs from a vehicle and correlation with analysis techniques. A rule based system can manage the data operations of a vehicle. A vehicle that is in a communications link with a network can also manage its activities based on real time, historical and predictive knowledge, without having all this knowledge processing on board. Such data processing would include the geo-spatial, internal functions and operator specific requirements. The rule based or analysis system would also incorporate the use patterns of a specific vehicle, or a specific user. A use pattern could be transferred from one operator to another or be shared to assist with navigation and operations. A vehicle operator or vehicle multiple operators or a vehicle network component or a vehicle in communication with another, could share or upload information that would assist with efficient operations, including fuel conservation and time management. Use patterns can be assigned to geospatial regions and be used for comparative analysis for such activities as efficient operation, safe travel, social media applications and navigation.

The present invention provides a vehicle operations system, including network and communications infrastructure, in order to optimize vehicle performance and provides numerous benefits including but not limited to connection to third party communications systems that will allow for tracking of position; the real time processing of this information is to allow for vehicle performance optimization; reduction of network load by pre-processing of data; and the support by display on the vehicle to allow internet based commercial and social services to be shared by drivers, operators, internet communities and other parties of interest such as marketing and third party service solutions.

In accordance with an aspect of the present invention, there is provided a system whereby the operational conditions of a vehicle could include but are not limited to internal operational state, near space traffic events, regional topography, patterns of use, and relationships with other vehicles and where the real time, historical or predictive state or conditions are to be used in a system that collects internal information from the vehicle or driver and shares this information on a private or public network. Such system can provide further analysis and reporting back to a driver, operator or vehicle. Such system may store such information on a mobile network where it may assign indices, use pattern data or raw data to a vehicle, driver, specific location, or region.

### The Data Collection and Management System

The data collection and management system 300 comprises of three major distributed parts; the vehicle centric data collection or user input system 330; the real time communications and analysis system 320; and the post processing or historical database 310. The vehicle centric real time data may be used to manage a vehicle without dependence upon a real time link up. It can provide analysis based on sensor based operational data and this can be combined with user or system updated patterns. The real time communications system would include: data from vehicle centric vehicle; data from post processing database; data from third party systems; data from other vehicles. The post processing database can create user context specific information, and more generalized scenario management which may be used to provide the basis for database comparison, prioritisation or input.

A context driven analysis system would allow for specific use cases to be analysed using a variety of mathematical algorithms. Such an analysis could be performed outside of the real time interface database. Such comparison system would allow for data to be used in a combination of randomized and deterministic algorithms where their use depends upon previously known or preset relationships, where the probability of and event or anomaly detection would be dependent upon the normal operations of a vehicle in comparison with real time data or with post analysis data or user determined settings. In essence a set of operational parameters would establish the normal expected response. Based on variations in operation performance or expected performance a set of business rules or operational guidelines will be automatically enabled. In one aspect of the invention, the prioritization of actions are broken down into use case processing that would be dependent upon user associated rules or reporting requirements.

One aspect of the invention is to include a systems user profile that can either manage the preferences of the user or set automated prioritization based on prior use. Such prior use may include vehicle operational habits such as acceleration, route track, time of day, as might be used to characterize the normal human impacts on the vehicle. Such a user profile can be transferred to different vehicles or used in a comparative analysis to optimize the use of vehicles in a similar pattern, using either real time analysis systems or post analysis. Patterns of analysis can be used to describe the user preferences for distinct geographical areas, allowing vehicle performance optimization or driver guidance to avoid or manage areas of complex navigation or allowing driver social media applications.

The rule based system would have both vehicle centric and networked components and the vehicle would be able to drive either autonomously or in real time communication with it's networked guidance systems. Vehicle centric systems would allow for optimization of vehicle performance parameters using predictive methods that interpret such characteristics as slope, location and speed. For example wheel torque under constant rotation speed, or speed under constant torque or regenerative braking could thus be modified to perform based on anticipated conditions, and real time performance versus expected performance could be shared amongst vehicles on a similar route. Control elements such as a continuously variable transmission would benefit from such anticipated actions to manage fuel consumption or regenerative brake use. Certain vehicle use cases would involve a rule based system to optimize user variable software tools, and enable communication with both vehicle centric or networked software tools or games. Certain types of vehicle centric data could be shared between vehicles and the data could be packaged as the solution to multiple algorithms such as piecewise functions including polynomial representations of data intervals.

With the present invention predictive analysis can be applied to many vehicle use cases. Active analysis of a vehicle can be used to both optimize and share vehicle performance characteristics. Vehicle telematics can be used in conjunction with network components, including computational precedents from apriori analysis, in order to optimize fleet management and predictive analysis, such as use, availability, maintenance, safety, security, social media applications and refuelling. Navigation systems can further optimize the systems performance to create route preferences based on immediate requirements, such as home-base return power calculations including potential energy requirements, total energy available, kinetic energy capture, fleet requirements, fastest route, shortest route, most fuel efficient route or safest route. Mobile data can be shared in two way communication with the vehicle and the management systems enabling real time optimization of third party software including games and fleet functions.

### On Board and Server Side Analysis and Presentation for Rapid Data Management

There are a number of stages in the processing and calculation of data that are captured on board a vehicle for real time analysis 320 and its post processing when data is transferred to a central processing computer. Further analysis and comparison of results is made and additionally, the data is prepared for display 230 and for storage.

The onboard analysis system uses a computational method 710 including real time connectivity to the server side analysis that further enables a multitude of applications, especially those needed to address the challenges that electric vehicles face such as range optimization and charging infrastructure and hence one objective of the onboard analysis is to present the result of range optimization algorithms whether performed on board or on the server.

The onboard analysis is centered around a reference calculation that uses the minimum amount of data in order to provide the vehicle operator with relevant data. The onboard calculation can be used as both a reference calculation when modeling complex analysis and as a reference on board a vehicle that is not connected to a network. In one embodiment of the system, the range error analysis algorithm is limited in its scope so as to eliminate the probability of introducing errors into the range analysis process. In the case of determining the amount of available energy for a vehicle to travel from one location to another, the algorithm would be different to the server side analysis as the maximum deviation from normal would be restricted and would be used to display only the probability of energy available to complete the journey, vs. the server side which would attempt to provide accurate route and energy data in absolute terms, should that be required.

In one embodiment, a very simple algorithm can be implemented using a geometric assessment of the route distance where the straight line distance d is the distance of the origin A point (x_{A}, y_{A}) to the destination B point (x_{B}, y_{B}) or AB

In this case, a deviation ε from the direct path AB can be determined by combined factors such as lights, traffic, multiple paths, hills etc, and is representative of the degree of variance from the ideal path d. ε is modeled on a maximum angular deviation from route AB as if the route were changed to go to AC and then CB such that both AC and CB are functions of AB where AC=fd₁=d/cos θ; and CB=fd₂=d*tan θ; with a maximum deviation of the angle of deviation being set at a default value of π/4.

An estimate of variance fε, or deviation from straight line distance is thus:

εd=fd₁+fd₂−d

The deviated distance fε could be set at a default value of cos θ=π/4 which represents the likelihood of having to travel through point C as if points {A,B,C,D} were the corners of a single city block. In this model, the deviation can be left at the default for testing and during machine learning. When the variable that leads to deviation can be determined, θ can be adjusted on the basis of a scale. Either the system can input a complexity value, or the operator can input his expected level of driving complexity or frustration, for instance a 0-5 scale could be used where each point on the five point scale represents θ=˜0.157 radians, a change to represent a maximum when θ=π/4 and is C is 90 degrees from A.

While computationally undemanding, such an equation can form the basis of a business rule that is reduced to a component of a rule based system 830 that does not let the deviation exceed a limit, and provides a simple term of reference for a vehicle operator to interface with, while still allowing a more complex analysis and more complex algorithm to proceed on the server side.

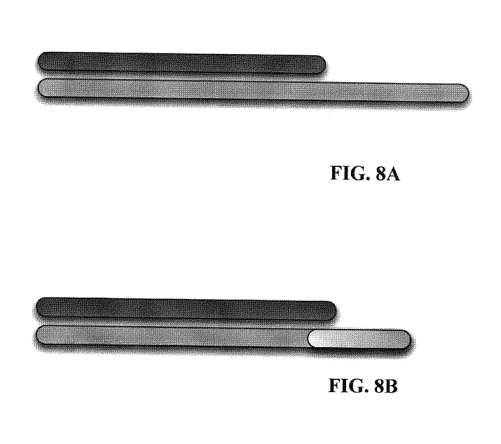

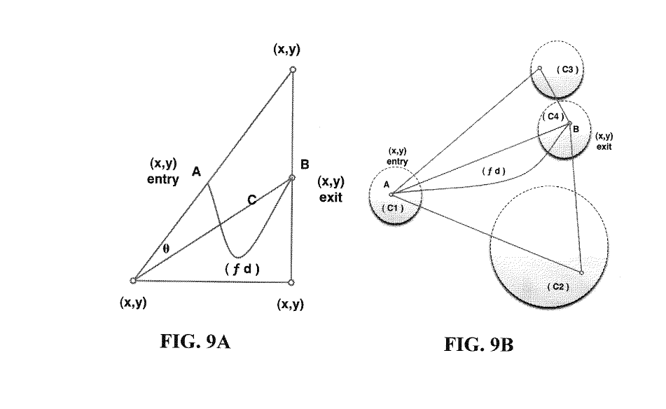

In one embodiment of this, a confidence measure can be displayed on the vehicle, FIG. 8b, where the server side can update the vehicle dashboard with an analysis that may conflict with the limited analysis from onboard, and may send an override message or an alert message to the vehicle operator. One simple variation to this would be to add known path data to upgrade the deviation data using the probability of a driver taking a similar path based on a routine of use or other apriori data.

Position data can be described as cartesian values at each node, origin or destination, (x_{N}, y_{N}, z_{N}), implying 3D spatial analysis, such as slope, or some other data could be used, such as acceleration, vibration, that were common to known area coordinates.

One embodiment of the invention calls for Fuel/Charge Representation, where adding probability data to charge representation. A deviated distance calculation can be used to compute fuel requirements or to display the errors, risks, probabilities of either a remaining charge, or a probable range. One option is to display route/charge distance variable with range/charge available. An algorithm would determine the fuel available and the straight line range. We can assume an average distance per charge factored by the available charge. The fuel required is calculated using the (x_{A}, y_{A}) origin and (x_{B}, y_{B}) destination and thus the direct distance.

Using the limited geometric model the direct distance represents the distance where cos θ=1 and has a deviation value of 0.

The Deviated Distance fε could be represented by a simple graphic of the charge needed vs the charge available, FIG. 8a.

The normalization of variables in a limited geometric model can also be achieved using measures that determine the total vertical gain, total vertical loss, and the operational efficiency. These can be updated in real time, or can use derivatives of scalar data in a time series, including the use of sensors, such as an accelerometer to capture real time variances, the use of a bandpass filters to reduce the impacts of low amplitude, high frequency or short duration sensor data.

In another embodiment of the invention, a single route could be broken up into a series of shorter segments, each being modeled by a limited geometric model, and that the average of the sum of the combined deviations could be used to define the available charge to complete a journey. This data could also be presented with greater confidence, and the degree of confidence could also be displayed in conjunction with the total available fuel or the probable charge needed to get to a destination.

### Server Side Analysis

In a more complex model, a combination of Bayesian probabilities and Markov Random Fields can be used. However, more complex analysis, especially in urban setting will require the use of driving areas or clusters 1001, that could determine the degree of complexity that might influence the route and fuel requirements. Such factors as the vehicle condition, driving and environmental conditions will play into the prediction 730 of fuel requirements. Other factors such as vehicle weight and terrain slope will be highly influential and need to be determined before a vehicle enters a new zone. All of these factors can be components of planning in a rule based system 200.

In one embodiment of the invention, the system would collect data and measure these factors in an iterative system 800, on a variable route, where areas can be broken down into numerous clusters, especially where known factors are highly influential such as bridges and complex roadways or other factors that can be added to the analysis in real time using weighted classification 720 and prediction 730, and such an analysis of fd 710 would result in a manageable way to handle vast amounts of data from complex cluster arrangements 1002. These clusters would be chordally represented by junction tree graphs and the complexity data processed with a Hugin algorithm as the system collects and distributes data about each cluster. In this manner, influencing factors can be managed in their affect on route choice. Clusters of known influencing points may vary in their significance as variables change. A vehicle coming into a cluster area may be highly influenced by certain variables such as weight vs. slope. Clusters would have an entry and exit point, and would be nodes summarized as of influence in a bayesian calculation of the probability of arriving at a destination with sufficient fuel. Such a probability could be layered into the graphic of fuel availability as in FIGS. 8a, 8b.

An algorithm or computational method 710 that is used in such an embodiment could capture data and provide a sequence of tasks including calculating derivatives, performing correlations to normal, relating clustering to cause and effects and rate of change and determining the relevance of changes between clusters (C); ΔC1: ΔC2; as part of the analysis 700 and iterative cycle 800. Further, the risk from the probabilities of how C1 might have an effect on C2 and could further provides the basis to compare data to consequences for risk interpretation and management.

In one embodiment of the invention, junction tree algorithms can be used to generalize variable elimination for efficient, simultaneous execution of a large class of queries, including computational methods 710, classification 720, and prediction 730, and these algorithms can take the form of normalizing and interpreting messages passing between nodes such as clusters, or sets of variables. Each area cluster starts with a normalized status and can be varied by the impacts of proximal clusters or by sub clusters, which might be area specific, or could be influenced by the limited geometric model or by cluster weighting or could be influenced by a function that includes all of the potential variables. The weighting of how one variable would influence another could be considered the density of each cluster, and in combination, the influences in a cluster area can define the factorized density of a cluster or its potential influence on the routing or fuel calculation algorithm or its presentation. By combining this potential with the potentials it receives from its neighbors, the algorithm can compute the probability in routing or the confidence in fuel availability using all significant variables. In one embodiment, a Hugin algorithm can be used to avoid repeated multiplications. The complexity of the algorithm can be scaled by the weighting of variables in conjunction with bandpass filters, such that the width of the junction tree, can be computed or set by vehicle or network operators or by the influence of the vehicle on the cluster it is transiting, where the algorithm is then vehicle specific.

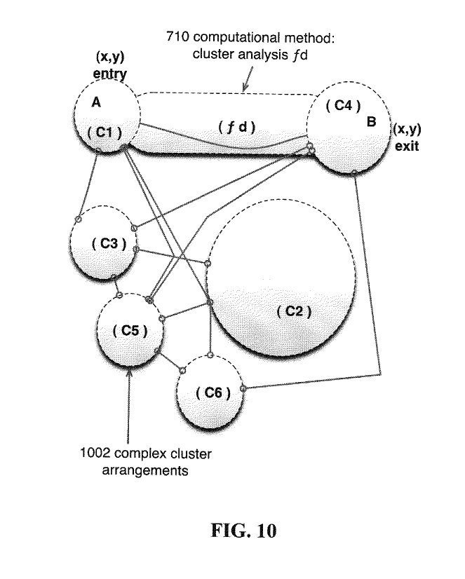

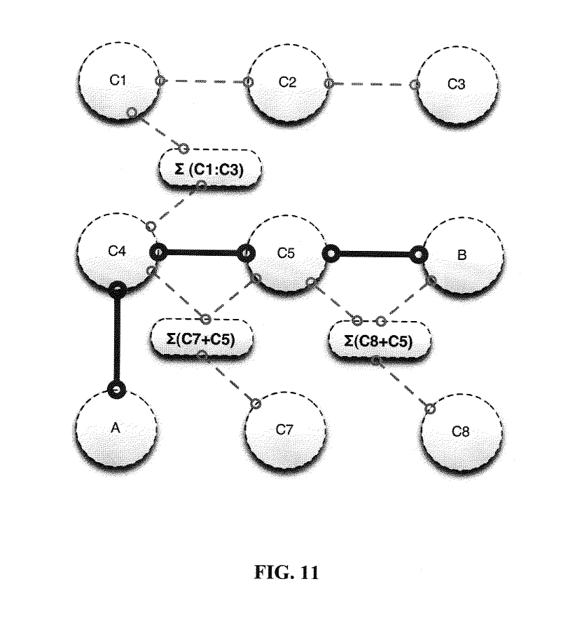

In a bayesian network a real time analysis method 710 would include multiple variables per vehicle, multiple vehicles per cluster, and multiple clusters in an area including vehicle clusters/local clusters/area clusters, within an undirected graphical model with computed or manually input variances. The algorithm would use data elimination, including classification 720 and prediction 730 in order to minimize the computational load of the transitive relationships as a vehicle moves through a cluster or from one cluster to another. The transitive relationships can be those that have unaffected routes, where there is distance between each pair of clusters is not affected by variable; routine groupings or classifications 720 where there is a know and repeatable or predictable impact 730, and running changes where the influence of one cluster on another creates a unique set of impacts on the vehicle transit, or a deviation from a rule 830 in a decision management system 810. This can be part of an iterative cycle 800. Messaging and thus computational mathematical transitive relationships within clusters can be controlled by their projected impact on the vehicle transit through a cluster, and would form an analysis method 710 to be part of an iterative cycle 800. The influences of messaging between clusters will depend on the weighted value of a cluster as a vehicle transits a cluster field, FIG. 11. A known impact can form a rule 830 which can be normalized in an decision management process 810, for by changing the routing, such that an optimized pathway is the function including the least interferences, including the impacts of specialist or user knowledge 850, or the impacts of ambient conditions 860. In this model, the transit of a vehicle can be considered as the cluster analysis of fd where d is influenced by the set of clusters {C₁ . . . Cn} FIG. 10. The cluster analysis of fd may also lead to the system being able to classify the conditions in which the dominant influences have impacts on a vehicle 720, and further lead to a predictive analysis based on the classification 730, thus allowing a more streamlined data analysis based on weighting of classification rather than raw data.

### Reporting System

A reporting system 600 will package data to simplify usage trends from vehicle systems use to drivers and network operators. The report of specific vehicle operations to drivers and network operators and other interested parties such as vehicle manufacturers and marketing agencies, will allow them to be more intuitive about the ongoing operations onboard vehicles without the need for a constant data stream. Data processing will create a predicted operational profile and a post analysis profile which can be presented as an algorithm interpolation and the comparison of the variables can be efficiently made without ever having to transmit all the vehicle data. Such data sets can be scaled to manage data transmission such that only change related data in the form of an algorithm variable needs to be transmitted either to or from a vehicle. Such processing of data can optimize the use of data such that in many cases the transmission of some data will not need to be transmitted in real time via a mobile network. This is particularly the case for high resolution data that does not represent any significant change, the on board vehicle processing system being able to determine the relevance or significance of data intervals. Some data can be stored on a network server or onboard the vehicle and transferred between the vehicle, the server, the driver or other networked component, on or off the vehicle or other vehicles, by a mobile data system such as either a Wi-Fi, drivers personal data memory card, or when network demand is reduced. This will have a dramatic effect of the scalability of the systems, allowing the smallest packets of real time data transmission and reducing the network burden.

A change report could be in the form of a difference between the predicted and actual performance, the routing performance, the battery performance, vehicle faults, driver preferences, driver performance, status reports, security reports and other variables as might be expected in the normal operation of a vehicle. Driver preferences can be in the form of pre or post driving questions that the driver or the network can generate to further optimize performance. These preferences can be shared with other drivers, or network operators to encourage best practice use patterns.

### Operators and Managers and Associated Rules

A corporate fleet managed system would have different operational requirements than a social group or an individual. A fleet might already have its own operational software and would be looking for specialized vehicle indicators only, such as time or distance to recharge, in order to manage deliveries or services within a certain area, which would impact cluster weighting. In this case the need for performance criteria would be very much determined by the practical business rules for the fleet. A social group might wish to optimize their group performance to drive where there is little traffic or along a scenic route, or drive as an input to a game scenario. An individual may wish to improve the personal driving habits or refine route preferences while driving.

Vehicle identification could be in the form of a personal profile of the driver, and profile of the vehicle performance or some combination of these features. A driver may have a performance profile that can be used to modify vehicle performance criteria to suit the driver, for instance, route profiles, or the actual physical characteristics of the driver such as height and weight may change the predictive route mapping, or other onboard vehicle parameters such as torque/speed or suspension settings or ergonomic factors such as mirror or seat adjustments.

As a result, the invention allows for the real time vehicle adjustments, and post analysis all which can be made based on type of vehicle, driver history, regional driving trends and conditions, and associative relationships between vehicles.

The invention calls for multiple vehicle communications methods within a distributed operational system with a mobile data network including cellular, Wi-Fi, internet and other methods as would be known to one familiar with the art. A subscription model would allow for web enabled social networking of vehicle communications on a use case basis.

### Separate Entities in a Distributed Network

Each vehicle system is designed to operate with or without the communications network. The vehicle is always associated with a user profile, whether it is owned, leased, rented etc. The vehicle/operator pair become a rule specific entity in a distributed learning network whereby the identity of an operator can be used to drive any vehicle, and that vehicle will by nature of the operator data, take on the preferred characteristics of the operator into its vehicle centric operational system.

The vehicle/operator pair are the top tier in computational performance, a vehicle centric system is supported by the communications and post processing data layers. In this manner, if the communications link is not available, the vehicle centric system can continue to function in a predictive manner, by using a priori data.

In this manner a vehicle that is following a known route can also follow known patterns of use, regardless of if the communications link is active. A driver or network operator or an automated system can use the use pattern data to characterize route preferences that would allow for easy interpretation of local conditions in a predictive or real time situation, such interpretation allowing for the intuitive display of such information.

### Geospatial Security

In one embodiment, a use case for a security system 533 would be to integrate with commonly understood geomatics technology. Owner/operator preferences will adjust the sensitivity of security response to real time data, and can also provide notification of vehicle optimal state to manage the geospatial conditions. Further the vehicle can incorporate geospatial analysis or patterns to ensure that the vehicle is being operated in a optimal state.

### Separate Entities in a Network

Each vehicle and operator is a separate entity in the network. This allows for either a vehicle or an operator to be associated independently. A vehicle might allow multiple operators for either personal or business reasons, and a driver operator might have his or her profile associated with multiple vehicles. The vehicle and driver environment would be constantly updated based on the predetermined preferences or settings. These preferences would act as inputs to a rule based system further allowing for optimization of real time processing requirements due to the limited need for complex multivariate change analysis. For instance the predictive aspects of what is happening on a driver dashboard can be displayed or shared on a network without a real time update.

### Communications Between Network Entities

In another aspect of the invention, a geospatial area or location may have characteristics that are assigned to it that would serve to automatically update driver or vehicle preferences and enable the use of geospatial preferences as a means of searching a routing data base to see which areas have been tagged with certain characteristics. Examples of this might be an area with bad road conditions, an area that stresses vehicle operations, an area that is difficult to navigate, or an area that has been noted as notoriously dangerous. In this manner both vehicle performance and driver input can be used to identify driving characteristics. Driver input could be made in post analysis.

A vehicle in the network works as a separate entity able to determine some of the attributes of one or more other vehicles in the form of validated cluster weightings, referencing both historical and real time information and able to provide limited processing ability on board the vehicle or able to prompt the real time communications and analysis system 320 by either an automated event or by user/driver prompt. Each vehicle entity is subsequently indirectly in contact with other vehicles in proximity through the network that have allowed shared communication. Further communication with internet applications could allow a variety of third party shared user functions or applications.

Because the evaluation process and location determination of entities are spread over a number of vehicles or vehicle operator pairs, and there is vehicle centric pre-processing, there is a faster evaluation and less data traffic over the network than if the central database were used to perform all the analysis and reporting evaluations and location determinations or requests. Hence the operator can become part of the real time programming process, and the results of his decisions are used in post processing analysis.

Additionally, each vehicle, and driver can have a set of rules that apply to them to enable the communications network. Each entity can reduce the amount of network data processing by examining data on an event basis, which will produce constant results for a time period. If so, an entity can, for example, eliminate the analysis complexity or the reporting requirements for real time data.

### Sensors

A vehicle with multiple accelerometers can derive the variations in conditions such as vehicle vibrations or acceleration in multiple axes. These in turn can be integrated to determine velocity or displacement. Patterns of accelerometer data can be used to characterize vehicle performance and when using pattern analysis can be used to determine vehicle operational parameters such as load, road conditions, tire and suspension performance. Other sensors such as optical spatial sensors and environmental sensors can be used as inputs to a vehicle specific data system 110 as would be known to one skilled in the art.

### System Operation

Reporting can be based on the results of spatial rules, and performed as specified for a spatial rule, or can be based on non spatial activities and actions can then impact the weighting of spatial rules. A reporting action can include communications with a vehicle, where certain functions can be optimized for performance. Such rules would allow for the integration of operator actions, predictive data, historical data and real time data to be used to optimize vehicle performance.

For instance, an operation could be a prompt, or internal network validation method, or a command or message to the operator or driver to follow a path that is known to be more economical for fuel consumption rather than the shortest route. Such a message might be in the form of a graphic as would be typical of internet mapping functions such as Google Maps.

Alerts 620, commands and actions 640, could be provided in other forms such as text messages, audible warnings including and interactive voice response system, graphics and icons to improve the simplicity of the communication.

There are five categories which can be used to describe features and components within the data management and processing system, external and geo spatial data of the pattern analysis modules 100, planning and display for plans and plan updates within the planning module 200, multi tiered database 300, personal data 400 and user preferences 500.

The vehicle specific data systems 110 can include but are not limited to such operational sensors 511 and environmental sensor 512 elements to measure, battery level, real time battery demand, torque, regenerative braking status, speed, direction, motor temperature, battery temperature and tire pressure, temperature/humidity measured at vehicle, accelerometer data about road surface, grade, or air quality. These may be used separately or in combinations to enhance vehicle operations especially energy efficient travel. Public data 130 can include information such as grade, elevation, temperature, traffic conditions in a mapping utility that can be used to evaluate the most efficient trip. A historical database 310 is used to enhance the geospatial data to assure that patterns from various vehicles can be compared to evaluate the most efficient trip with the efficiency patterns module 120. This in turn can be processed via a real time analysis system 320 database for later use or for context driven comparison for other unrelated vehicles. In combination these elements can be used to create dynamic mapping that provides efficient travel plans 210 and in combination with real time data can provide a real time analysis 320 and an updated travel plan 220. The ability to update plans in real time provides a measure of efficiency, and the display of this 230 allows for user input 330 to impact further decision making Drivers could also respond to prompts from the system using physical movements measured by sensors or other methods such as, speech, audible or visual cues. The real time analysis system 320 shares data with the updated plans module 220, captures data from the user input 330, and the vehicle data 110 and then performs an iterative analysis that updates the personal user pattern profile 420, and the historical database 310. This is managed through a secure communications uplink 531, a short term data analysis 532 and security communications 533. The historical database 310 can share information on the basis of post analysis modules including context 541, comparison 542 and prioritization 543. with the efficiency patterns module 120 and can have multiple tiers of data to be shared but secured at private/personal level, a systems subscription level and a public level such as a personal profile to be published 430 that could automatically update to social medial such as Facebook or Twitter. A personal digital key 410 will allow personal data, vehicle data, and security codes to be used to verify operations of the vehicle and the systems interface, including updates from the historical database 310 and to the secure user pattern profile 420 and to allow the system to update the published profile 430 and communication with a personal user database system 440 that allows for updates to user preferences especially those of planning 521 and performance 522.

### Electric Vehicle Algorithms and Models

Electric vehicle optimization can be achieved with algorithms that incorporate vehicle performance feedback on a real time basis in coordination with user specific patterns and shared data in an real time network. The state of charge of a battery is one measure of performance on a route that can be used to compare patterns with other vehicles.

A dynamic algorithm is applied to generate a trip model and a driving cycle based on driver's itinerary input which includes geographical data, such as departure, destination and preferred route and time data such as departure time and arrival time. When the historical data of the preferred route is used to optimize the performance, the conditions of previous trips of the same vehicle or those of other vehicles can be used as reference. In a down scaling of traditional public traffic data, there may not be enough relevant data to provide a route adjustment, however, real time data from other vehicles in a similar route pattern my give local information to adjust either the route or the drive cycle. A continuous Markov decision process is one method whereby a reward function can be calculated and associated battery performance or other vehicle performance characteristics. These in turn could be compared to expected results. Further, a down scaling of data to respond in only certain circumstances, would allow algorithms to be optimized to run only on demand or based on a trigger such as a change in vehicle performance, a time or a location based event. Such an event could be characterized by on one of the many existing methods of monitoring of charge depletion control, however, the data could be used in an optimization based on historical patterns or in a comparison with predictive data.

The acceleration and deceleration model of a specific individual vehicle, that compensates for distances and times associated with speed change cycles, such as stop-start and slow down-speed up patterns, are used in a model where driving conditions and real time assessment of event related analysis can include operating cost, energy use spatial components of delay or surge in comparison to the anticipated results.

Acceleration, velocity and displacement can all be used in a model that further processes data to enable a comparative performance, on the same route, between vehicles, or between the same vehicle at a different time. Retention of peak and mean acceleration data for period of a trip can be used rather than retaining all the data from the trip. Similarly a derivative of the displacement in a period or interest could be the constant acceleration, which could be compared to the instantaneous acceleration at any time. Performance measures such as total tractive force, mass, speed, acceleration, energy rate, efficiency parameter which relates to electric energy consumed provided by the power-train, an efficiency parameter which relates to electric energy consumed during acceleration, and efficiency parameters based on trip time, battery energy, dynamic state of the vehicle such as vehicle speed, regenerative energy, battery state of charge can also be used to create patterns of use on a route. These and other patterns of systems performance can be used to compare real time vehicle operations to predicted values and be used by drivers to adapt driving techniques or select new routes to further optimize performance.

Furthermore performance criteria can be adjusted to provide the real time data that would assist drivers to attain their immediate needs, which might be finding the shortest path, finding the quickest path, or using the least amount of energy.

Display of the data can be such that predictive parameters can be displayed in comparison to real time parameters or historical patterns, and a suggested operational plan can be presented to the driver in order to meet the desired objectives. Such a display could compare acceleration, speed, distance or direction and make suggestions of these parameters.

The system operates in a report 600, analysis 700, iterative cycle 800 process where each of these report, analysis and interaction features provides an opportunity for vehicle drivers and operators to interact with the process to define their requirements.

The report 600 aspect of the network has three outputs for display 610 of relevant data, alerting 620 of events based on preferences, and the creation of reports 630 such as may be required to satisfy the rules of the iterative cycle or the display of real time driving data. The reporting module gathers information from the vehicle centric systems and analysis modules, vehicle data 110, the driver user input 330, a historical database 310 or from a public data 130.

The analysis 700 aspect of the network gathers information from the alert 620 and report 630 systems and also responds to events such as travel plans 210 and serves to update plans 220. The analysis aspect can have separate portions that function at the historical 310, real time 320, user input 330, personal digital key 410, or patterns module 120. There are three components to the analysis module for computational 710, classification 720, and prediction 730. Accordingly the invention calls for the analysis of data to include the integration, derivative or exclusion of certain events to be compared in a timeline using a variety of methods and types of algorithms and a predictive analysis can be made by comparing the prior events

In the invention, one type of decision and probability analysis consists of forward chaining where the existing data is combined with a process of making a logical judgment based on the apriori circumstances and conclusions that were used as the basis for apriori input to rules, and the use of these apriori inputs and circumstances to extract more data until a postulate can be made. The process using forward chaining searches the inference rules until it finds one where a logical truth can be inferred with some probability, a consequent which would add more data to the existing data, classification or rules around the apriori circumstances.

Yet further, another type of decision and probability analysis consists of backward chaining where an expected result can be used in context with he apriori circumstances and conclusions that were used as the basis for apriori input to rules, and the existing circumstances or the results of forward chaining to determine if the circumstances for the expected results are likely and the probability of this.

In some cases the analysis system presents only the probability of a situation matching known apriori circumstances and conclusions and that these are always considered to have some weighting of accuracy. However for the simplicity of real time calculations, the algorithm can sometimes use apriori data to match events with modus ponens inference.

The iterative cycle 800 aspect of the network has three major components including decision management 810, requirements 820, and rules 830. The rules components gather information from the computational 710, classification 720, and prediction 730 aspects. The iterative cycle uses this information in the decision management context to update travel plans 220, display options 230, prompt for user input 330, modify the published profile 430, validate the secure user pattern profile 420, and the real time communications and analysis system 320 including the event operations 534, security communications 533, time scaled data analysis 532, and communications uplink data 531. The iterative requirements are preset by user preferences 500, or use case 840 including specialist knowledge 850, or ambient conditions data 860.

### Communications and Decision Making Architecture

The network 900 and its components are connected using an application programming interface or API. There are the mobile data network API's 910 and the network server API's 920 which connect the vehicles 901 to the various services.

The vehicle dashboard API 913 is the API between network specific 952 or 3rd party dashboard applications 951 and the supplied libraries that will allow access to vehicle functions or driver communication with functions or with applications interface with local services. Examples would include functions to do driver notifications through a common queuing and display system, access track information or to populate additional layers on the map display with 3rd party info. Such an API would use a Java interface or other software standards as would be well known.

The vehicle services API 911 is the API between dashboard applications and network data centre 950 that will allow access to information and services encapsulated therein. Examples would include access to historical track information, and real time information such as nearby scooter friends, as well as providing a conduit through the data centre to any Internet based applications utilizing the network infrastructure services API 922 to provide fleet support, such as emergency road services for instance. Some aspects of the vehicle services API are only available to network software modules on the dashboard such as session log-in, position reporting, whilst others are open to third party applications. This API would use a JSON or XML-based web interface with security and other enhancements or other software standards as would be well known.

The driver services API 912 is the API between a mobile application such as a program running natively on the mobile data network 940 such as the driver phone 941 or vehicle manager phone 942 or other mobile device, and the network data centre 950. It allows access to a subset of functionality that would be typically needed by third party mobile applications to interact with the network system and vehicles. Examples would include the ability to be notified of and control vehicle security events, driver safety, or other complex information to be pushed to the vehicle, or for the driver to update the network preferences or to message scooter friends. This API would use a JSON or XML-based web interface with security and other enhancements or other software standards as would be well known.

The infrastructure services API 922 is a set of APIs between third party applications which can be either Internet or mobile-based, that allow integration of independent software providers to support and be supported by the network eco-system. This API set can encapsulate the vehicle services and driver services APIs and then add functionality specific to fleets and corporate applications. It can be secured via a security certificate or other permission so to be available to approved connections. This API would use a JSON or XML-based web interface with security and other enhancements or other software standards as would be well known.

The charging services API 921 is the API between network data centre and battery management systems 960 such as charging stations 961, battery management technologies, mobile charging vehicles and electricity suppliers allowing the secure exchange of information related to charging events, and the brokering of financial transactions for charging services 962 by third parties, to the vehicle and drivers. Examples would include communications related to battery or charge point reservation, power and or battery pricing and actual charging transactions. This API would use a JSON or XML-based web interface with security and other enhancements or other software standards as would be well known.

The network architecture or components may be changed to allow for virtual infrastructure such as backup and recovery processes to improve efficiency, and mobility.

Together, all these components form a communications system and mobile data network, which is designed to allow vehicle function with none, any or all features in operation. Programming of preferences can be as simple as the systems monitoring the vehicle or driver operations, and making automated adjustments, or by the driver or owner or operator setting preferences either on the vehicle or by interfacing with the network including the personal digital key 410.

### Rules

A typical rule based system can be enabled on the basis of real time events or by post analysis. There are typically application interfaces with business rules, or utility controls, and often in a network environment. In some cases a user interface can be used to allow communication with the rules to optimize functions. The programming techniques of rule based systems and expert systems are common knowledge to those familiar with decision management systems.

A set of rules 830 is deployed within the data network 900 in multiple centers of decision management. In the present invention, the technique of rule based systems is being used with a distributed architecture that will allow systems to function whether or not in communication with the network, and in doing so the rule based architecture on the vehicle is designed to primarily process real time vehicle data, while the networked architecture is designed to monitor the results of the numerous vehicle rule systems, and compare these to expected results. User preferences would allow selective communication between the vehicle and the network, allowing some information to remain private and within the drivers personal network and post processing database, and some to be published to the driver's media portal and some to be published to the network operators database for post analysis and sharing between vehicles. In this manner any number of rule based scenarios can be compared and managed for different purposes. A rule scenario for determining the fastest route through a city grid at a certain time would be very different to a rule scenario that might determine the most energy efficient route or to sustain travel for an extended period. The priorities of rules and their weighting would change and enable the vehicle operator to determine what information to display on the user interface.

Conservation rules—include an effort to improve the use of a vehicle battery, a number of features on the vehicle are being monitored in order allow for conservation of vehicle energy by suggesting performance criteria to the driver or by providing automated controls or alerts based on vehicle performance during certain drive cycles.

Social rules—include the ability to share information between drivers and vehicles in order to allow users to participate in internet based utilities or to share driver preferences and data. These can be further adapted to be specialized rules between certain vehicles for personal reasons or for gaming or business needs.

Reporting rules—include a those where drivers may set the reporting requirements of a specific vehicle or their real time or post analysis reporting to enable it to be used for processing in certain ways including performance measures to be used privately, or for sharing of data to enhance comparative analysis between vehicles and or between similar routes.

Rate of change rules—include an expected change would happen within some time domain. Rate changes can be modified to alert on the basis of the first significant change and the preferences can be set for follow on alerts to assure the over sending of alerts does not desensitize the driver to significant detail.

Such rules may be implemented to interact with functions of the vehicle and may be weighted by the vehicle owner and or operator to help the vehicle meet environmental, operational, social, and ease of use requirements. These components of a vehicle operation system and mobile data network allow for many additional features and applications to be added to a vehicle and driver interface. In one embodiment of the invention, the network will allow for an interface for third party applications and services to be added on to the network at a network operators or drivers choice. This interface would be in the form of an online store where the network could set the standards and performance requirements for vehicles based on any of the features in the total system.

The invention will now be described with reference to specific examples. It will be understood that the following examples are intended to describe embodiments of the invention and are not intended to limit the invention in any way.

### EXAMPLES

### Example 1

A vehicle operating system can examine travel records and indices within clusters or groups of clusters to create a travel plan that propose a route for an electric vehicle. Confidence measures can be displayed indicating the probability of being able to complete a journey with a certain certainty. This will serve to resolve the anxiety that a driver might have about taking on a certain journey, including making stops or detours and still being able to complete the journey without risk of total battery depletion. By allowing drivers to modify plans simply by making vehicle operation changes, the real time analysis systems can support adaptive processing based on prior known patterns of drivers habits, optimal vehicle performance and real time or previously known conditions or changes.

### Example 2

A vehicle operating system would be able to use network features to interpret the geospatial characteristics of a cluster or groups of clusters, to integrate with locally known or shared features of the region to enable a driver who is previously unfamiliar with an area to be able to take a route that satisfies rules for efficiency that would otherwise be only known to those who had local knowledge. Drivers could adjust their response to proposed changes in routes based on their intuitive response and could accept or decline new route choices or prompt the network for further options including opening a call with a customer service representative.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A vehicle communication, analysis and operation system including hardware, firmware and software for managing vehicles by onboard analysis centered around a reference algorithm that uses the minimum amount of data in order to provide the vehicle operator with relevant data, employing inputs from data clusters including vehicle and correlation with analysis techniques in real time, or with historical and predictive knowledge.
a) that further enables a multitude of applications, range optimization and electric vehicle charging infrastructure
b) that further enables range optimization algorithms performed on board

2. The system where a vehicle is equipped with multiple accelerometers can derive the variations in conditions such as vehicle vibrations or acceleration in multiple axes and in combination with other data form a data cluster that can transit through a geometric model.
a) Where this data can in turn be integrated to determine velocity or displacement or patterns to characterize vehicle performance
b) Where driver actions are monitored to allow for vehicle actions to be used as response mechanisms in the vehicle centric analysis system.
c) Where a series of two or more accelerometers could be used in an steering handle which to allow a driver to use tapping motions to communicate while steering.

3. A vehicle communication, analysis and operation system including hardware, firmware and software for managing vehicles using a cluster analysis technique by connectivity to server side analysis and can further provide a vehicle operator or network operator with relevant data, employing inputs from data clusters including vehicle and correlation with analysis techniques in real time, or with historical and predictive knowledge.
a) that further enables a multitude of applications, range optimization and electric vehicle charging infrastructure
b) range optimization algorithms whether performed on the server or onboard the vehicle.
